(19) United States
(12) Patent Application Publication
(10) Pub. No.: US 2007/0246317 A1
(43) Pub. Date: Oct. 25, 2007

(54) Hydrodynamic torque transmitting device and lock-up device using for it

(75) Inventor: Naoki Tomiyama, Hirakata-shi (JP)

Correspondence Address: GLOBAL IP COUNSELORS, LLP, 1233 20TH STREET, NW, SUITE 700, WASHINGTON, DC, 20036-2680, US

(73) Assignee: Exedy Corporation, Neyagawa-shi (JP)

(21) Appl. No.: 11/730,888

(22) Filed: Apr. 4, 2007

(30) Foreign Application Priority Data
Apr. 20, 2006 (JP) JP 2006-117171

(51) Int. Cl. F16H 45/02

(52) U.S. Cl. 192/3.29; 192/70.18

(57) ABSTRACT

A lock-up device 5 includes a piston 51 axially movably and rotatably supported by the turbine 10, a damper mechanism 7 that elastically connects the piston 51 with the turbine 10 in the rotational direction, a first friction plate 56 located between the front cover 2 and the piston 51 and axially movably and non-rotatably supported by the piston 51, and a second friction plate 57 located between the piston 51 and the first friction plate 56. The second friction plate 57 is axially movably and non-rotatably supported by the front cover 2.

### CROSS-REFERENCE TO RELATED APPLICATIONS

This application claims priority to Japanese Patent Application No. 2006-117171 filed on Apr. 20, 2006. The entire disclosure of Japanese Patent Application No. 2006-117171 is hereby incorporated herein by reference.

### BACKGROUND OF THE INVENTION

1. Field of the Invention

The present invention generally relates to hydraulic torque transmitting devices and lock-up devices used by them. More specifically, the present invention relates to hydraulic torque transmitting devices such as torque converters and fluid couplings, and lock-up devices used by them.

2. Background Information

One example of a hydrodynamic torque transmitting device is a torque converter. A torque converter has three vane wheels (an impeller, a turbine, and a stator) arranged in the interior thereof, and serves to transmit torque by the circulation of the operating oils or working fluid in the interior thereof. The impeller is fixed to a front cover connected to an input rotary member. When the impeller is rotated, the operating oils flow from the impeller toward the turbine to rotate the turbine. Consequently, the torque is output from the turbine to the input shaft. Many types of torque converters having the above structure include lockup devices.

A lockup device is arranged in a space between the turbine and the front cover, and can mechanically couple the front cover to the turbine in order to transmit directly torque from the front cover to the turbine. As one type of such lockup devices, lockup devices having three friction surfaces have been proposed, for example, as seen in Japanese Laid-Open Patent Publication JP63-72968.

Lockup devices like this having three friction surfaces include a damper mechanism, a first friction plate, a second friction plate, and a piston. The damper mechanism has a hub flange rotatable with the turbine, a retaining plate and clutch plate rotatable relative to the hub flange, and torsion springs for elastically connecting the hub flange with the retaining plate and clutch plate in the rotational direction. The torsion springs are held by the retaining plate and clutch plate. The first friction plate is engaged with the retaining plate and clutch plate such that the first friction plate cannot rotate but can move in the axial direction relative to the plates. The second friction plate is engaged with the radially outermost portion of the front cover such that the second friction plate cannot rotate but can move in the axial direction relative to the front cover. The piston is fixed to the retaining plate and clutch plate by rivets. The piston is disposed near an axial side of the second friction plate toward the turbine, and can move in the axial direction with the damper mechanism due to the pressure change of the operating fluid.

In the lock-up device, when the operating oils in a space on an axial side of the piston near the front cover are drained, the hydraulic pressure in a space on an axial side of the piston near the turbine becomes higher than that in the space on an axial side of the piston near the front cover so that the piston moves toward the front cover in the axial direction. Accordingly, the piston presses the second friction plate, the second friction plate presses the first friction plate, and the first friction plate presses the frictional surface of the front cover, thereby carrying out the frictional engagement. As a result, the torque of the front cover is transmitted from the frictional surfaces and the second friction plate to the retaining plate and clutch plate via the first friction plate and the piston, and further to the hub flange via the torsion springs, and is finally output to the turbine (hereinafter, this state will be referred to as “in a lock-up engagement state”).

In the lock-up engagement state, when the operating oils are supplied into the space on an axial side of the piston near the front cover, the hydraulic pressure in the space on an axial side of the piston near the front cover becomes higher, thus, the piston moves toward the turbine in the axial direction. Accordingly, the piston stops pressing the second friction plate toward front cover in the axial direction, and the first friction plate stops pressing the frictional surface of the front cover, thereby releasing the frictional engagement. As a result, the torque of the front cover is not transmitted from the frictional surfaces and the second friction plate to the retaining plate and clutch plate via the first friction plate and the piston, thus, the torque is output to the turbine by the fluid drive of the impeller (hereinafter, this state will be referred to as “in a lock-up disengagement state”).

In this lock-up device, however, since the first friction plate is supported by a member provided in the damper mechanism, the piston, which acts as an input member of the damper mechanism, and the first friction plate are unlikely to respond to the movements of each other in some cases. In this case, the responsiveness of the lock-up operations such as the lock-up engagement and the lock-up disengagement is deteriorated.

In view of the above, it will be apparent to those skilled in the art from this disclosure that there exists a need for an improved hydraulic torque transmitting device and lock-up device used for it. This invention addresses this need in the art as well as other needs, which will become apparent to those skilled in the art from this disclosure.

### SUMMARY OF THE INVENTION

It is an object of the present invention to improve the responsiveness of the lock-up operations in a lock-up device having three frictional surfaces.

According to a first aspect of the present invention, a lock-up device for a hydrodynamic torque transmission device is located between a front cover and a turbine to connect mechanically the front cover with the turbine. The lock-up device has a piston, a damper mechanism, a first friction plate, and a second friction plate. The piston is axially movably and rotatably supported by the turbine. The damper mechanism elastically connests the piston with the turbine in the rotational direction. The first friction plate is located between the front cover and the piston and is non-rotatably supported by the piston. The second friction plate is located between the piston and the first friction plate and is axially movably and non-rotatably supported by the front cover.

In the lock-up device, since the first friction plate is non-rotatably supported by the piston, the piston and the first friction plate are likely to move simultaneously. Consequently, the responsiveness of the lock-up operations is improved.

Meanwhile, it is required to ensure the accuracy of adjusting gaps between the frictional surfaces in the vicinity of the first friction plate of the lock-up device. The reason is that if the gaps between the frictional surfaces are large, the responsiveness of the lock-up operations is deteriorated, and if the gaps between the frictional surfaces are small, a drag torque is generated during the lock-up disengagement. Accordingly, if the first friction plate is fixed to the piston, for example, it is difficult to adjust positioning of the first friction plate alone, and to adjust the gaps in the vicinity of the first friction plate. As a result, the responsiveness of the lock-up operations is deteriorated or the drag torque is generated at the lock-up disengagement.

Therefore, a lock-up device for a hydrodynamic torque transmission device according to a second aspect of the present invention is a device of the first aspect, wherein the first friction plate is movably supported by the piston axially. Accordingly, it becomes easy to adjust the gaps in the vicinity of the first friction plate, so that the deterioration of the responsiveness of the lock-up operations can be prevented, and the drag torque during the lock-up disengagement operation can be reduced.

A lock-up device for a hydrodynamic torque transmission device according to a third aspect is a device of the second aspect, wherein the first friction plate is formed with a connecting hole into which a member provided in the piston is fitted in the axial direction. Accordingly, it is possible to realize a simple structure in which the first friction plate is supported by the piston movably.

It should be noted that “the member provided in the piston” preferably means a member integrally formed with the piston or fixed to the piston, i.e., a member that can neither move in the axial direction nor rotate relative to the piston. The member may be a part of the piston or a member separate from the piston.

A lock-up device for a hydrodynamic torque transmission device according to a fourth aspect of the present invention is a device of the third aspect, wherein the first friction plate has a tubular portion that extends in the axial direction and has an inner circumference corresponding to the connecting hole. Accordingly, the attitude of the first friction plate to the piston can be stabilized.

A lock-up device for a hydrodynamic torque transmission device according to a fifth aspect of the present invention is a device of the fourth aspect, wherein the damper mechanism includes a driven member, a drive member, an elastic member, and a connecting member. The driven member is non-rotatably connected to the turbine. The drive member is located rotatably relative to the driven member. The elastic member elastically connects the drive member with the driven member in the rotational direction. The connecting member axially movably and non-rotatably connects the piston with the drive member. The connecting member is connected to the piston by the member provided in the piston.

A lock-up device for a hydrodynamic torque transmission device according to a sixth aspect of the present invention is a device of the fifth aspect, wherein the member provided in the piston has a shank, a fixing portion, and a head. The shank penetrates the piston and the connecting member in the axial direction. The fixing portion is formed at one end of the shank and has an outer diameter larger than that of the shank. The head is formed at the other end of the shank to pinch the piston and the connecting member between the fixing portion and the head. Further, the head has an outer diameter that is larger than that of the shank. The first friction plate is supported by the head such that first friction plate can move in the axial direction relative to the piston.

In the lock-up device, since the first friction plate is supported by the head of the member provided in the piston that connects the connecting member with the piston, it is unnecessary to add a new component to support the first friction plate, thereby preventing the number of components from increasing.

It should be noted that the member provided in the piston constituted by the head, the shank, and the fixing portion may be a member constituted by a plurality of members corresponding to each element as well as an integral member.

A lock-up device for a hydrodynamic torque transmission device according to a seventh aspect of the present invention is a device of the sixth aspect, wherein the head is fitted into the connecting hole.

A lock-up device for a hydrodynamic torque transmission device according to an eighth aspect of the present invention is a device of the second aspect, wherein the damper mechanism includes a driven member, a drive member, an elastic member, and a connecting member. The driven member is non-rotatably connected to the turbine. The drive member is arranged to be rotatable relative to the driven member. The elastic member elastically connects the drive member with the driven member in the rotational direction. The connecting member non-rotatably connects the piston with the drive member elastically in the axial direction. The drive member further has an annular drive member main body, and a plurality of protrusions that extends radially outward from the drive member main body. One end of the connecting member is fixed to the protrusion. The other end of the connecting member is fixed to the piston by the member provided in the piston. The member is located between the adjacent protrusions.

In the lock-up device, since the member provided in the piston is disposed between the adjacent protrusions, it is possible to reduce the axial dimension of the lock-up device, and to ensure easily a space into which the connecting member elastically deforms.

A lock-up device for a hydrodynamic torque transmission device according to a ninth aspect of the present invention is a device of the first aspect, wherein the second friction plate has an engagement portion that is axially movably and non-rotatably engaged with the front cover. A flow path area of the engagement portion is substantially the same as a flow passage area between the front cover and a radially inner portion of the second friction plate in the axial direction.

Accordingly, the operating oils flow smoothly in the vicinity of the first friction plate and the second friction plate so that the responsiveness of the lock-up operations can be improved and the drag torque at the lock-up disengagement can be reduced.

It should be noted that the phrase “the flow path areas are generally the same as each other” may indicate a case in which the flow path areas are very close to each other to an extent that the responsiveness of the lock-up operations can be improved as well as a case in which the flow path areas are perfectly matched.

According to a tenth aspect of the present invention, a hydraulic torque transmitting device has the front cover to which torque is input from an engine, an impeller forming a fluid chamber with the front cover, the turbine being located opposed to the impeller, and a lock-up device according to any of the first through ninth aspects being located between the front cover and the turbine.

Since the hydraulic torque transmitting device has any of the lock-up device according to any of the first through ninth aspects of the present invention, the responsiveness of the lock-up operations is improved.

In a lock-up device and a hydraulic torque transmitting device according to the present invention, with the above-described structures, the responsiveness of the lock-up operations is improved.

These and other objects, features, aspects, and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a schematic longitudinal cross-sectional view of the torque converter according to a first preferred embodiment of the present invention;

FIG. 2 is a partial schematic longitudinal cross-sectional view of a lock-up device of the torque converter;

FIG. 3 is an alternate partial schematic longitudinal cross-sectional view of the lock-up device;

FIG. 4 is a schematic elevational view of the lock-up device;

FIG. 5 is a fragmentary perspective view of the lock-up device;

FIG. 6 is an alternate fragmentary perspective view of the lock-up device;

FIG. 7 is still another fragmentary perspective view of the lock-up device;

FIGS. 8(a) to 8(c) are a detailed views of engagement portions between a second friction plate and a lug plate of the lock-up device;

FIG. 9 is a view corresponding to FIG. 2 of the lock-up device while engaged;

FIG. 10 is an alternate view corresponding to FIG. 3 of the lock-up device while engaged; and

FIGS. 11(a) and 11(b) are views corresponding to FIG. 4 of the lock-up device showing the lock-up engagement operation.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

Hereinafter, embodiments of hydraulic torque transmitting devices and lock-up devices used for them according to the present invention will now be described with reference to the figures.

### (1) Overall Structure of the Torque Converter

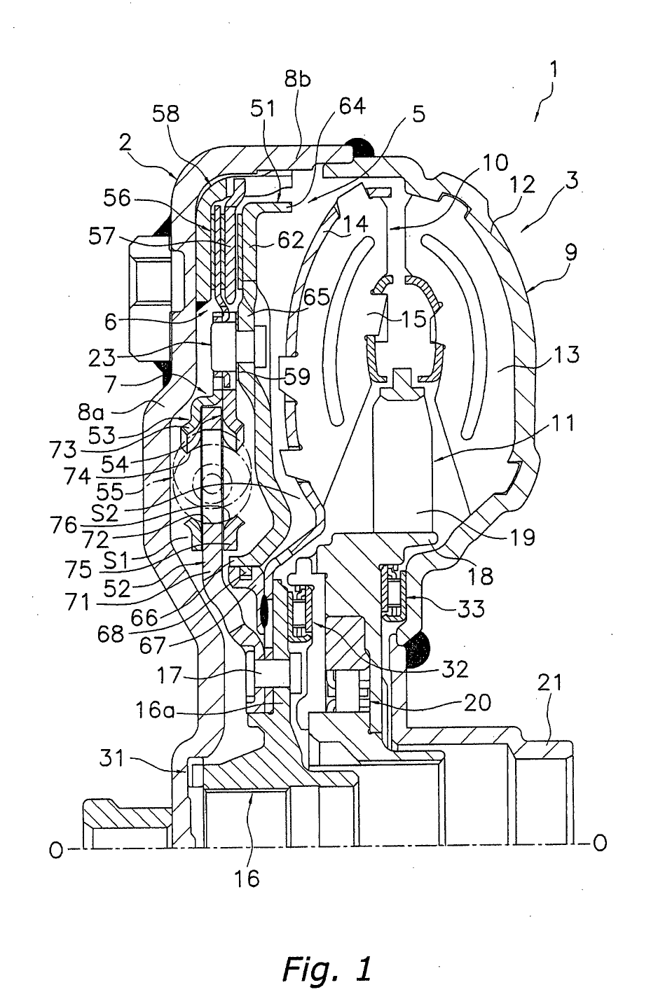

FIG. 1 is a schematic cross-sectional view of a torque converter 1, which is a hydrodynamic torque transmitting device employing a lockup device according to a first preferred embodiment of the invention. The engine (not shown) is arranged on the left side in FIG. 1, and the transmission (not shown) is arranged on the right side in FIG. 1. In FIG. 1, O-O represents the rotation axis of the torque converter 1.

The torque converter 1 is a device to transmit torque from crankshaft (not shown) of the engine to the input shaft of the transmission, and is constituted by a front cover 2 to be fixed to the input member, a torque converter main body 3 including three types of vane wheels (i.e., an impeller 9, a turbine 10 and a stator 11), and a lock-up device 5.

The front cover 2 is a circular disk-shaped member, and primarily formed from a cover disc 8a, and a radially outer cylindrical portion 8b extending toward the transmission in the axial direction from the radially outer portion of the cover disc 8a. The radially outer cylindrical portion 8b is fixed to an impeller shell 12 of the impeller 9 by welding.

The impeller 9 is primarily formed from the impeller shell 12, a plurality of impeller blades 13 fixed to the inner side of the impeller shell 12, and an impeller hub 21 fixed to the radially inner portion of the impeller shell 12.

The turbine 10 is arranged in the fluid chamber, and is opposed to the impeller 9. The turbine 10 is primarily formed from a turbine shell 14, a plurality of turbine blades 15 fixed to the turbine shell 14, and a turbine hub 16 fixed to the inner periphery of the turbine shell 14. The turbine hub 16 is formed with a flange 16a extending radially outward. The radially inner portion of the turbine shell 14 is fixed to the flange 16a by a plurality of rivets 17 with a hub flange 52 later described. The input shaft (not shown) of the transmission is spline-engaged with the inner circumference of the turbine hub 16.

The stator 11 is arranged axially between the radially inner portions of the impeller 9 and the turbine 10, and serves to regulate the flow of the operating oils or working fluids from the turbine 10 toward the impeller 9. The stator 11 is primarily formed from an annular stator carrier 18, and a plurality of stator blades 19 arranged on the outer peripheral surface of the stator carrier 18. The stator carrier 18 is supported on a fixed cylindrical shaft (not shown) via a one-way clutch 20. A first thrust bearing 31 is arranged axially between the front cover 2 and the turbine hub 16, a second thrust bearing 32 is arranged between the turbine hub 16 and the stator 11, and a third thrust bearing 33 is arranged between the stator 11 and the impeller hub 21. Ports that allow the operating oils to flow to both sides in the radial direction are formed in the portions where the first through third thrust bearings 31 to 33 are arranged.

### (2) Structure of the Lockup Device

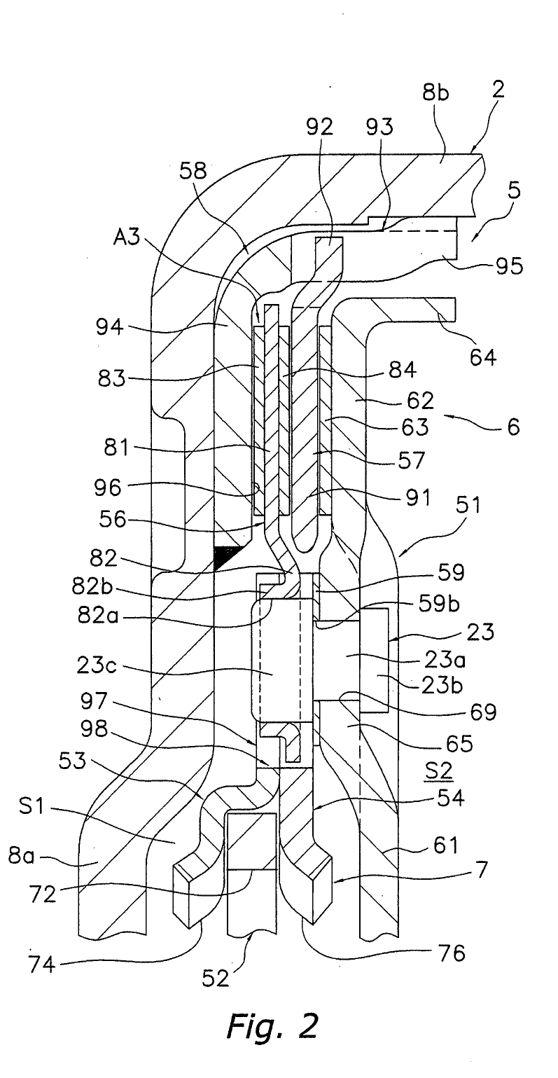

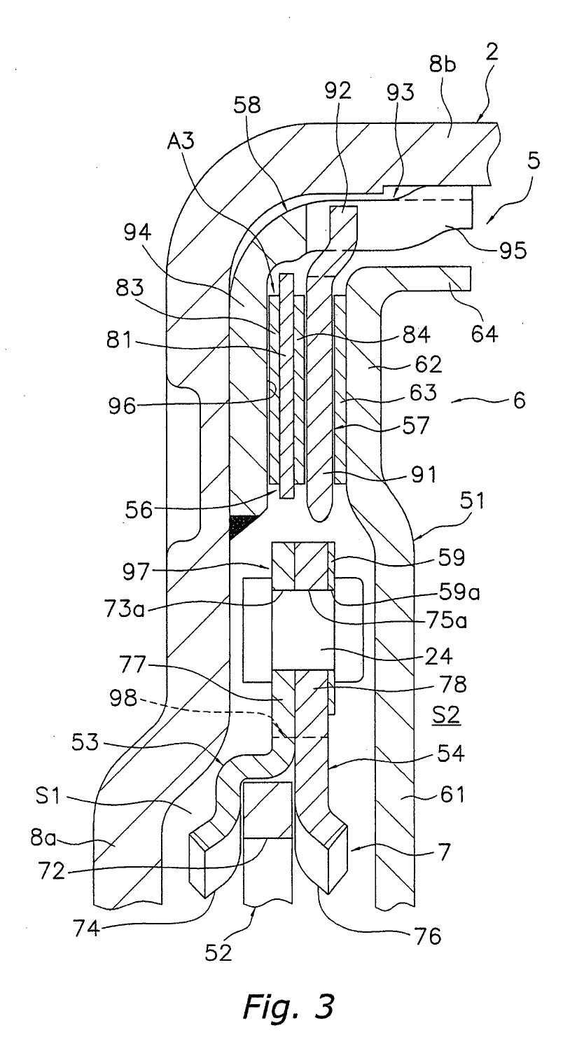

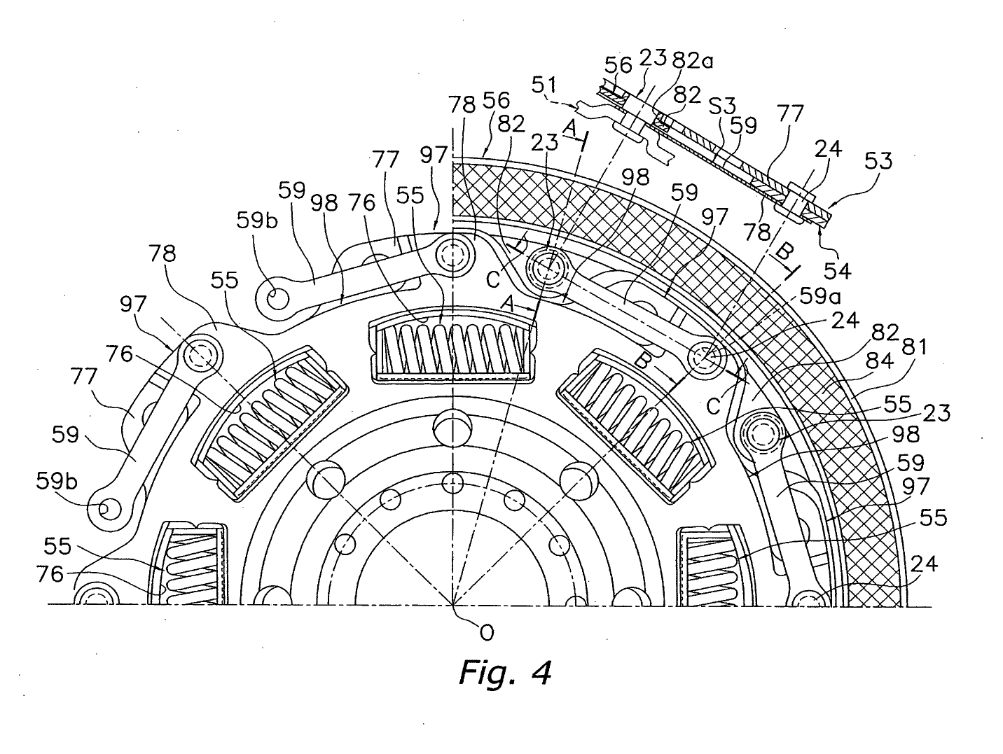

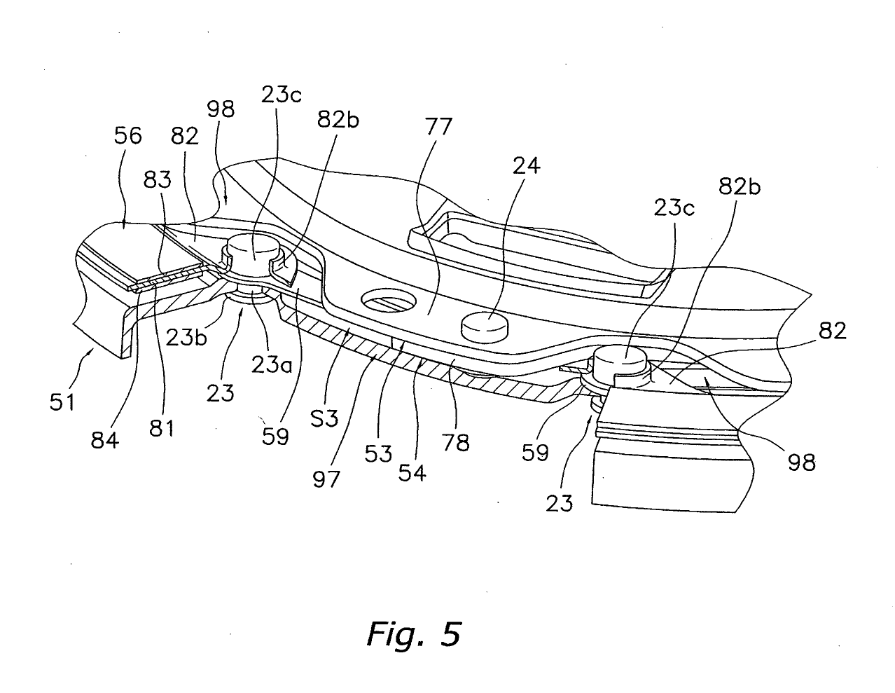

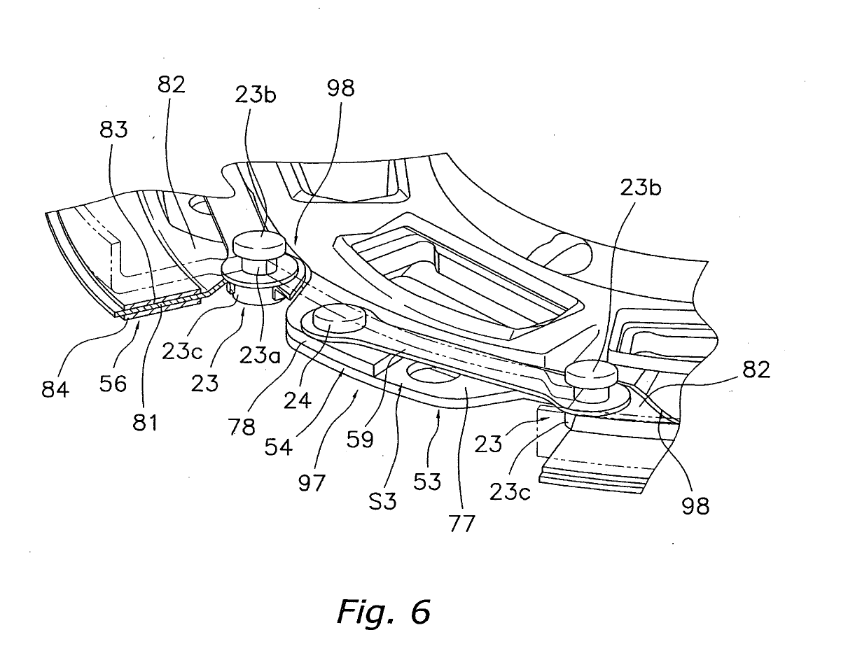

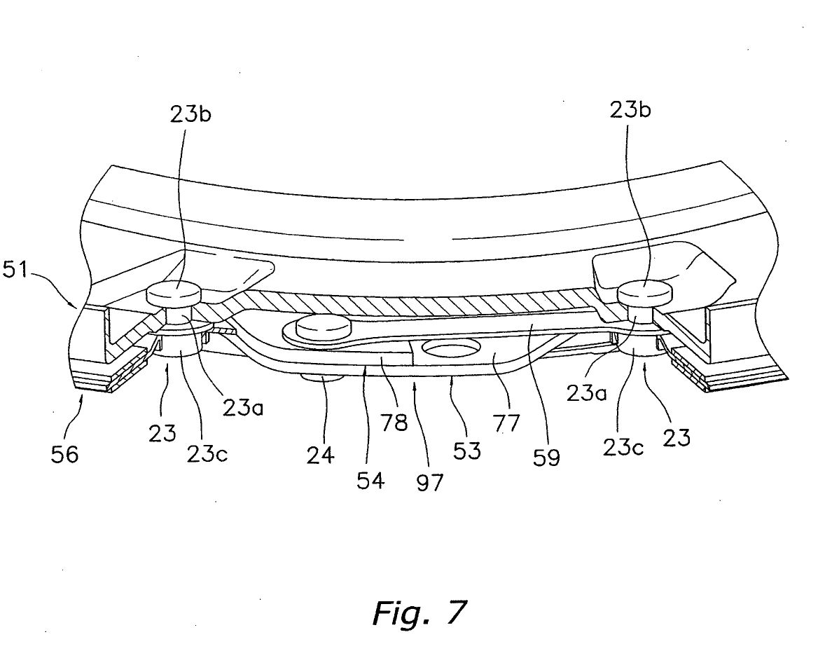

A description will be made on the lock-up device 5 referring to FIG. 1 through FIG. 5. FIG. 2 is a fragmentary longitudinal cross-sectional view (a cross-sectional view cut along A-A in FIG. 4) of the lock-up device 5. FIG. 3 is a fragmentary longitudinal cross-sectional view (a cross-sectional view cut along B-B in FIG. 4) of the lock-up device 5. FIG. 4 is an elevational view (illustrated by removing the piston 51 and the lug plate 58) of the lock-up device 5 seen from the turbine side. FIG. 5 is a fragmentary perspective view of places at and around the strap plates 59 from the radially outer side near the front cover 2. FIG. 6 and FIG. 7 are fragmentary perspective views of places at and around the strap plates 59 from the radially outer side near the turbine 10. It should be noted that the upper right figure in FIG. 4 is a cross-sectional view cut along C-C in FIG. 4. In FIG. 5 through FIG. 7, the torsion springs 55 are omitted, and parts of the piston 51 and the first friction plate 56 are cutout to illustrate the internal structure. In FIG. 6, the piston 51 is omitted.

The lock-up device 5 is provided with a clutch mechanism 6 to be connected with the front cover 2, and a damper mechanism 7 to connect elastically the clutch mechanism 6 with the turbine 10 in the rotational direction, and serves to couple mechanically the turbine 10 and the front cover 2 in accordance with need. Thus, the lock-up device 5 functions as a clutch mechanism and a damper mechanism. As shown in FIG. 1, the lock-up device 5 includes the piston 51, the hub flange 52, a clutch plate 53 and a retaining plate 54, a plurality of torsion springs 55, a first friction plate 56, a second friction plate 57, a lug plate 58, and a plurality of strap plates 59. The piston 51 is axially movably and rotatably supported by the turbine 10. The hub flange 52 is a driven member that is non-rotatably supported by the turbine 10. The clutch plate 53 and the retaining plate 54 are drive members that are arranged to be rotatable relative to the hub flange 52. The torsion springs 55 are elastic members that elastically connect the hub flange 52 with the clutch plate 53 and the retaining plate 54 in the rotational direction. The first friction plate 56 is located between the front cover 2 and the piston 51. The second friction plate 57 is located between the piston 51 and the first friction plate 56. The lug plate 58 is fixed to the front cover 2. The strap plates 59 are connecting members that axially movably and non-rotatably connect the piston 51 with the clutch plate 53 and the retaining plate 54.

The piston 51 is a member provided to perform switching of the lock-operations of the lock-up device 5, and is primarily formed from a disc-like piston main body 61. The piston main body 61 is a disc-like and annular member that extends in the radial direction to divide a space between the front cover 2 and the turbine 10 into two in the axial direction. As seen in FIGS. 1 and 2, the radially outer portion of the piston main body 61 is an annular and flat pressing portion 62. The pressing portion 62 has an axial-engine side to which a frictional facing 63 is attached. A radially outer cylindrical portion 64 extending toward the transmission in the axial direction is formed at the outer periphery of the pressing portion 62. A plurality of (eight in this embodiment) intermediate protrusions 65 arranged in the circumferential direction is formed at a radially intermediate portion of the piston main body 61 disposed radially inward of the pressing portion 62. The intermediate protrusion 65 is a part of the piston main body 61 protruding toward the engine in the axial direction. A radially inner cylindrical portion 66 extending toward the engine in the axial direction is formed at the inner periphery of the piston main body 61. The inner circumferential surface of the radially inner cylindrical portion 66 is supported by the outer circumferential surface of an annular piston support plate 67 fixed to the turbine hub 16 axially movably and rotatably.

The piston support plate 67 is fixed to a part of the radially inner portion of the turbine shell 14 by welding, where the hub flange 52 and the turbine shell 14 are fixed by the rivets 17. Between the radially inner cylindrical portion 66 and the outer circumference of the piston support plate 67 is provided a seal ring 68. Accordingly, the space S1 between the front cover 2 and the piston 51, and the space S2 between the piston 51 and the turbine 10 are sealed off from each other at their radially inner portions.

The hub flange 52 is a member to output the torque from the lock-up device 5, and is primarily formed from a disc-like hub main body 71. The hub main body 71 has, as described above, the radially inner portion fixed to the turbine hub 16, and is an annular member extending radially outward from there. The hub main body 71 is formed with a plurality of windows 72 extending in the circumferential direction, in which the torsion springs (coil springs) 55 are disposed.

The clutch plate 53 and the retaining plate 54 are members to transmit the torque from the piston 51 to the damper mechanism 7, and is an integral rotary member located on axial sides of the hub flange 52 toward the engine and the transmission, respectively. More specifically, as seen in FIGS. 1, 3, and 4, the clutch plate 53 is primarily formed from a disc-like plate main body 73, windows 74 that hold axial engine-sides of the torsion springs 55 and are in contact with the circumferential ends of the torsion springs 55, and a plurality of (eight in this embodiment) fixing portions 77 extending radially outward from the plate main body 73. The retaining plate 54 is primarily formed from a disc-like plate main body 75, windows 76 that hold axial transmission-sides of the torsion springs 55 and are in contact with the circumferential ends of the torsion springs 55, and a plurality of (eight in this embodiment) fixing portions 78 extending radially outward from the plate main body 75.

The windows 74 and 76 are located at positions corresponding to the windows 72. When the torsion springs 55 are compressed between the windows (74 and 76) and the windows 72, the clutch plate 53 and the retaining plate 54 are elastically connected with the hub flange 52 in the rotational direction.

The plate main bodies 73 and 75 annularly extend radially outward over the outer periphery of the hub flange 52, and the fixing portions 77 and 78 at the radially outer portions are fixed to each other by rivets 24. The fixing portions 77 and 78 are formed with plate through-holes 73a and 75a, respectively, and through which the rivets 24 pass (refer to FIG. 4). Accordingly, the clutch plate 53 and the retaining plate 54 are formed with a plurality of protrusions 97 at the radially outer ends, and between the adjacent protrusions 97 are formed recesses 98 respectively.

The strap plates 59 are members provided to connect the piston 51 with the clutch plate 53 and the retaining plate 54 axially movably and non-rotatably, and are strip-shaped members composed of an elastically deformable material such as spring steel. More specifically, each strap plate 59 is formed with a first plate through-hole 59a at one end in the longitudinal direction and a second plate through-hole 59b at the other end in the longitudinal direction. The first plate through-hole 59a of each of the strap plates 59 is located so as to correspond to the plate through-hole 75a of the retaining plate 54, and the rivet 24 therein fixes the strap plate 59 to the clutch plate 53 and the retaining plate 54 (refer to FIG. 3). The second plate through-hole 59b of each of the strap plates 59 is located so as to correspond to plate through-hole 69 of the piston 51, and rivet 23 therein fixes the strap plate 59 to the intermediate protrusion 65 of the piston 51 (refer to FIG. 2, and FIG. 5 through FIG. 7). As described above, the strap plates 59 axially movably and non-rotatably connect the clutch plate 53 and the retaining plate 54 with the piston 51 so that the torque can be transmitted from the piston 51 to the clutch plate 53 and the retaining plate 54 through the strap plates 59.

The elastic force of the strap plates 59 elastically connects the piston 51 with the clutch plate 53 and the retaining plate 54 in the axial direction. When the strap plates 59 are in a stress-free state, between frictional surfaces of the pressing portion 62 of the piston 51, the first friction plate 56 (later described), the second friction plate 57, and the lug plate 58 are formed passages A3 in the axial direction.

The first friction plate 56 is a disc-shaped member to transmit the torque with the piston 51, and is primarily formed from an annular plate main body 81, annular frictional facings 83 and 84 attached to the axially opposite surfaces of the plate main body 81, and a plurality of (eight in this embodiment) support portions 82 extending radially inward from the plate main body 81. The first friction plate 56 is supported via the support portion 82 by the piston 51 axially movably and non-rotatably. Specifically, as shown in FIG. 2 and FIG. 5 through FIG. 7, the support portion 82 includes a tubular portion 82b extending toward the engine and a through-hole (connecting hole) 82a formed around the inner circumference of the tubular portion 82b, and a part of the rivet 23 fixed to the piston 51 penetrates the through-hole 82a. More specifically, the rivet 23 is made of a shank 23a penetrating the plate through-hole 69 of the piston 51, a fixing portion 23b formed at one end of the shank 23a, and a head 23c formed at the other end of the shank 23a. The outer diameter of the fixing portion 23a is larger than that of the shank 23a but smaller than that of the head 23c. The intermediate protrusions 65 of the piston 51 and the strap plates 59 are pinched between the fixing portions 23b and the heads 23c of the rivets 23. The head 23c protrudes out of the piston 51 toward the engine in the axial direction, and the head 23c is inserted into the through-hole 82a of the support portion 82. This structure makes it possible for the piston 51 and the first friction plate 56 to rotate integrally but to move relatively in the axial direction.

Tilting of the first friction plate 56 to the piston 51 in the axial direction is restricted by the tubular portions 82b and the rivets 23. As a result, the attitude of the first friction plate 56 to the axis of rotation can be stabilized, and the first friction plate 56 can be moved in the axial direction while keeping the frictional surfaces of the piston 51 and the first friction plate 56 parallel with each other.

The second friction plate 57 is a member to input the torque from the front cover 2 to the lock-up device 5, and is primarily formed from a disc-like plate main body 91 between the first friction plate 56 and the pressing portion 62 of the piston 51 in the axial direction, and a plurality of (sixteen in this embodiment) claws 92 arranged in the circumferential direction, the claws 92 extending radially outward from the outer periphery of the plate main body 91.

The lug plate 58 is a member that is fixed to the front cover 2 to support the second friction plate 57 such that the second friction plate 57 cannot rotate but can move in the axial direction relative to the front cover 2. The lug plate 58 is primarily formed from a lug cylinder 93 located radially inward of the radially outer cylindrical portion 8b of the front cover 2, and a lug disc 94 that extends radially inward from the axial engine-side periphery of the lug cylinder 93 along the inner surface of the cover disc 8a of the front cover 2 and is fixed to the front cover 2 by welding. The lug cylinder 93 is formed with a plurality of (sixteen in this present embodiment) engagement claws 95 as engagement portions to engage the claws (engagement portion) 92 of the second friction plate 57 with the front cover 2 axially movably and non-rotatably. The engagement claws 95 are formed by cutting out parts of the lug cylinder 93 in the axial direction. A frictional surface 96 that is very close to, axially opposed to, and configured to contact the frictional facing 83 of the first friction plate 56 is formed at a surface of the lug disc 94 toward the first friction plate 56.

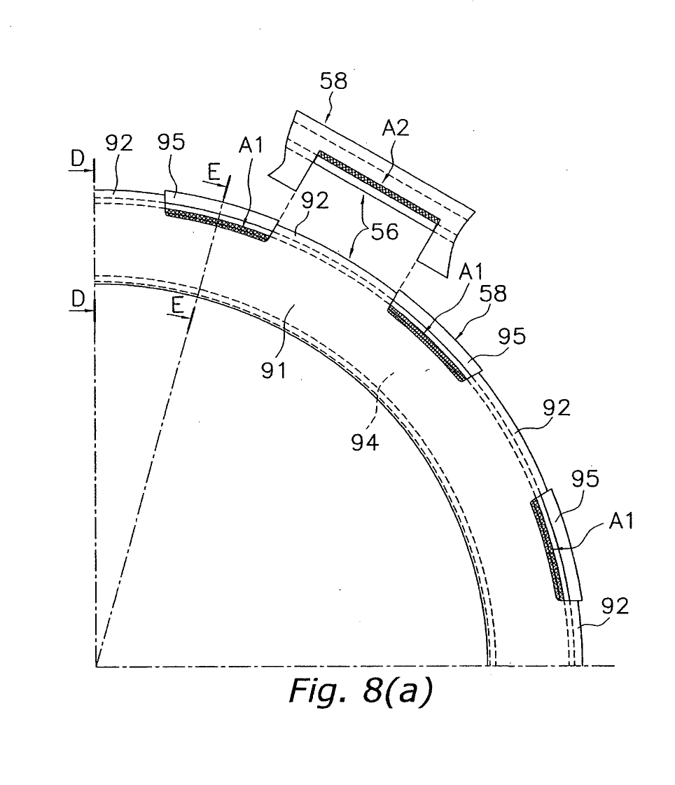

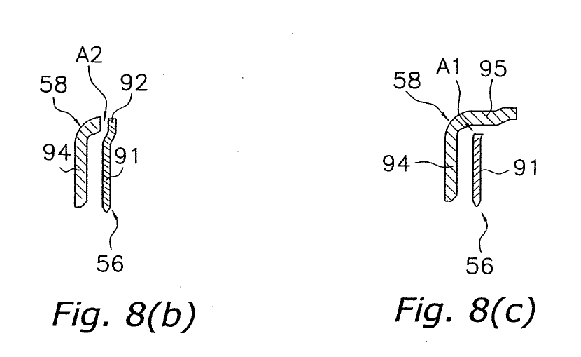

The flow path area in the vicinity of the engagements between the claws 92 and the engagement claws 95 is set to be generally the same as the flow path area in the vicinity of the frictional facings 83 and 84 of the first friction plate 56. FIGS. 8(a) to 8(c) are detailed views showing the engagement portions between the second friction plate 57 and the lug plate 58. FIG. 8(a) is a schematic elevational view showing the first friction plate 56 and second friction plate 57 engaged with each other, FIG. 8(b) is a cross-sectional view cut along D-D in FIG. 8(a), and FIG. 8(c) is a cross-sectional view cut along E-E in FIG. 8(a).

As shown in FIGS. 8(a) to 8(c), a plurality of (twelve in the present embodiment) passages A1 is defined between the engagement claws 95 and the plate main body 91 in the radial direction. Also, a plurality of (twelve in this present embodiment) passages A2 is defined between the lug disc 94 and the claws 92 in the axial direction. The passages A1 are spaces through which the operating oils mainly flow in the axial direction, and the passage A2 are spaces through which the operating oils mainly flow in the radial direction, the passages A1 and A2 communicating with a space in the vicinity of the frictional surfaces of the first friction plate 56.

Meanwhile, as shown in FIG. 2 and FIG. 3, during the lock-up disengagement, annular passages A3 are defined between the frictional facing 83 of the first friction plate 56 and the lug disc 94 in the axial direction, and between the frictional facing 84 and the second friction plate 57 in the axial direction.

A total flow path area of the passages A1 and A2 is set to be generally the same as the flow passage area of the passage A3. In other words, the inlet flow path area substantially coincides with the outlet flow path area in the vicinity of the frictional surfaces of the first friction plate 56. Accordingly, the operating oils flow smoothly at the lock-up operations, and the responsiveness of the lock-up operations is improved. 100591 Furthermore, as shown in FIG. 4 through FIG. 7, the protrusions 97 formed by the fixing portions 77 and 78 of the clutch plate 53 and the retaining plate 54, the support portion 82 of the first friction plate 56, the strap plates 59 and the rivets 23 and 24 are substantially arranged along the same circle. More specifically, the radially inner portion of the first friction plate 56 including the support portion 82 has a shape complementary to the radially outer portion of the clutch plate 53 including the fixing portion 77. Further, the support portion 82 and the rivets 23 are disposed in the recesses 98 (more specifically, between the fixing portions 77 of the clutch plate 53 in the circumferential direction). The strap plates 59 are located at positions corresponding to the recesses 98 to define a space S3 equivalent of a thickness of the fixing portion 78 between the strap plates 59 and the fixing portion 77 in the axial direction. This structure makes it possible to reduce the axial dimension of the lock-up device 5 and to ensure a space into which the strap plates 59 are deflected.

As described above, in the lock-up device 5 of the present embodiment, the clutch mechanism 6 is constituted by the piston 51, the first friction plate 56, the second friction plate 57, the strap plates 59, and the lug disc 94 of the lug plate 58. The damper mechanism 7 is constituted by the hub flange 52, the clutch plate 53, the retaining plate 54, and the torsion springs 55.

### (3) Operation of the Torque Converter

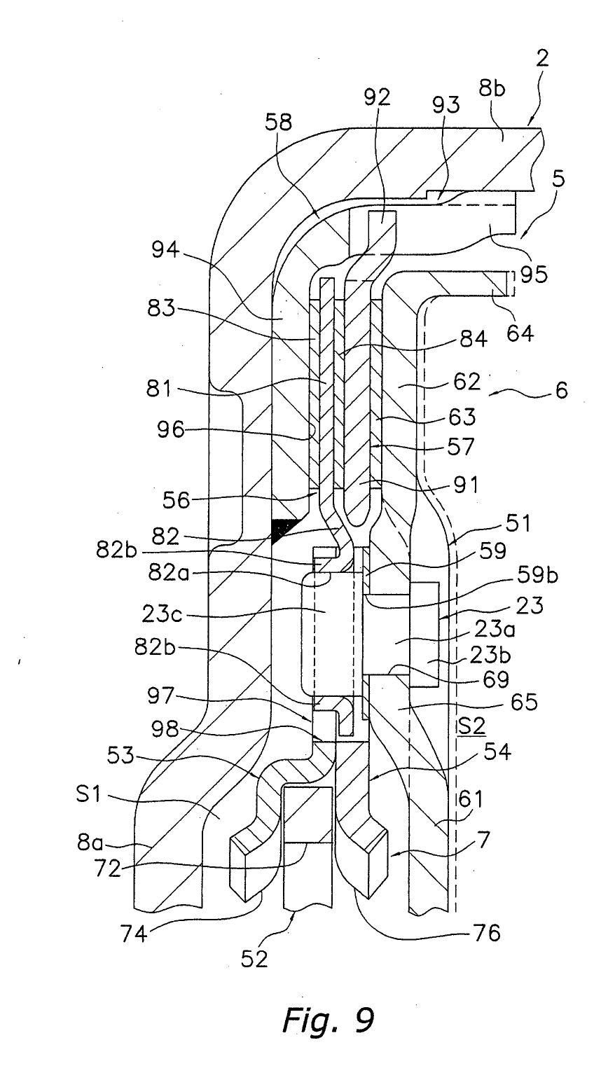

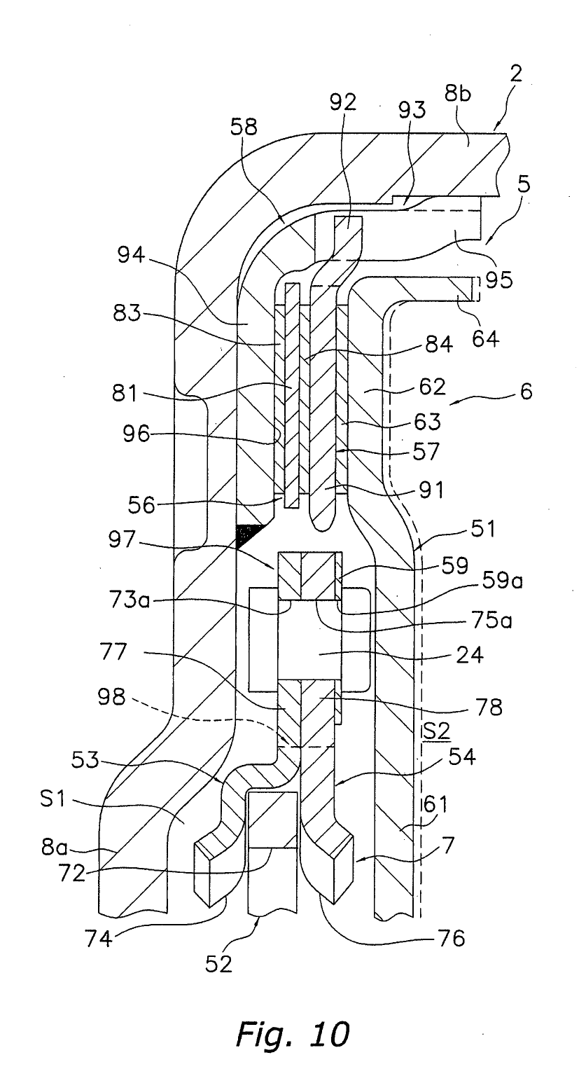

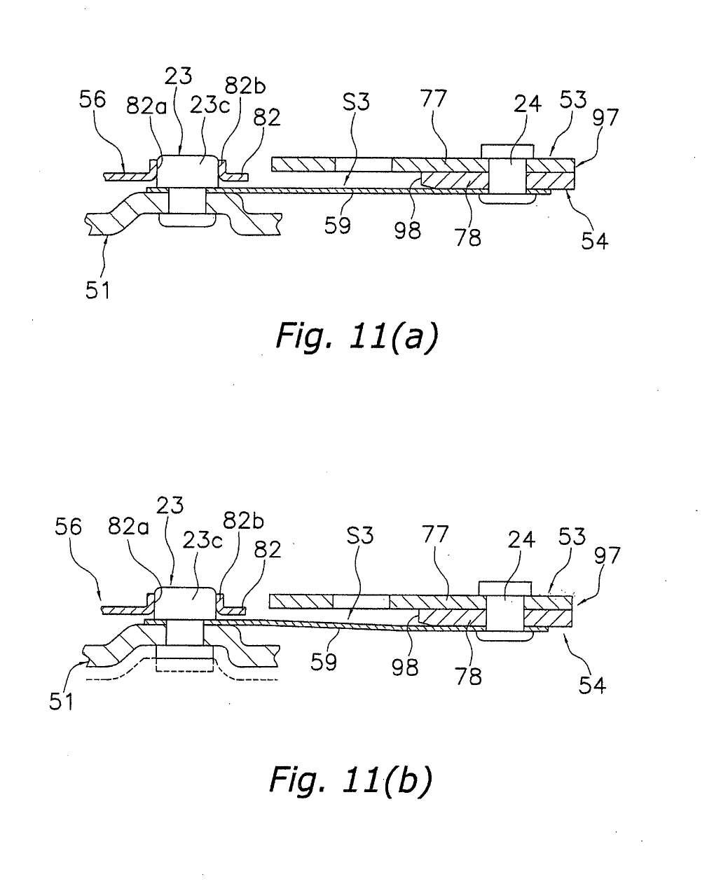

Next, referring to FIG. 1 through FIG. 11, a description will be made on the operation of the torque converter 1. FIG. 9 and FIG. 10 are views of the lock-up device during the lock-up engagement operation in the first embodiment, FIG. 11(a) is a fragmentary cross-sectional view during the lock-up disengagement operation, and FIG. 11(b) is a fragmentary cross sectional view during the lock-up engagement operation.

The torque from the crankshaft of the engine is input to the front cover 2 via the flexible plate (not shown). When the lock-up operation is not carried out at the lock-up device 5, the following operation is performed. The impeller 9 rotates to flow the operating oils from the impeller 9 to the turbine 10, and the flow of the operating oils drives the turbine 10 to output the torque of the turbine 10 to the input shaft (not shown).

When the speed ratio of the torque converter 1 rises and the rotational speed of the input shaft reaches a predetermined value, the operating oils in the space S1 is drained through the oil passage in the input shaft. Accordingly, the hydraulic pressure in the space S2, which is on an axial side of the piston 51 near the turbine, becomes higher than the hydraulic pressure in the space SI, which is on an axial side of the piston 51 near the front cover in the axial direction so that the piston 51 moves toward the front cover 2 as shown in FIG. 9 through FIG. 11. Consequently, between the piston 51 and the lug disc 94 of the lug plate 58, the first friction plate 56 and the second friction plate 57 are sandwiched for the frictional engagement. As a result, the torque input into the front cover 2 is input into the piston 51 and the first friction plate 56 by the frictional engagement, and is transmitted to the retaining plate 54 and the clutch plate 53 through the strap plates 59. The torque of the clutch plate 53 and the retaining plate 54 is transmitted to the hub flange 52 through the torsion springs 55, and is finally output to the turbine 10 (hereinafter, this state will be referred to as “lock-up engagement”).

Since the first friction plate 56 is supported by the rivets 23 provided in the piston 51, not provided in the damper mechanism 7, during the lock-up engagement operation, the movement of the first friction plate 56 is likely to correspond to the movement of the piston 51, and the responsiveness at the lock-up operations is improved.

When the operating oils are supplied into the space S1, which is on an axial side of the piston 51 near the front cover, during the lock-up engagement operation, the hydraulic pressure in the space S1, which is on axial side of the piston 51 near the front cover becomes higher so that the piston 51 moves toward the turbine 10 in the axial direction. At this time, the piston 51 moves back to the original position (an axial position when the strap plates 59 is in a free state) by the elastic force of the strap plates 59 (refer to FIG. 2 and FIG. 3). Consequently, the sandwiching of the first friction plate 56 and the second friction plate 57 between the piston 51 and the lug disc 94 of the lug plate 58 is released, thus, releasing the frictional engagement. Accordingly, the torque of the front cover 2 is transmitted to the turbine 10, not through the lock-up device 5, but by the fluid drive between the impeller 9 and the turbine 10 (hereinafter, this state will be referred to as “lock-up disengagement”).

The first friction plate 56 and the second friction plate 57 return to a free state in the axial direction because the pressure by the piston 51 is released. In other words, the torque transmission by the lock-up device 5 is interrupted.

### (4) Effects of the Invention

As described above, in the lock-up device 5, since the first friction plate 56 is non-rotatably supported by the piston 51, the movements of the piston 51 and the first friction plate 56 are likely to correspond to each other so that the responsiveness of the lock-up engagement and disengagement operations are improved. Furthermore, since the first friction plate 56 is axially movably supported by the piston 51, it becomes easy to adjust the gaps in the vicinity of the first friction plate 56. Accordingly, it is possible to prevent a drop in responsiveness of the lock-up engagement and disengagement operations, and to reduce the drag torque during the lock-up disengagement operation. Furthermore, the engagement between the tubular portion 82b of the first friction plate 56 and the head 23c of the rivets 23 stabilizes the attitude of the first friction plate 56 to the piston 51, improves the responsiveness of the lock-up engagement and disengagement operations, and reduces the drag torque during the lock-up disengagement operation. Furthermore, in the lock-up device 5, since the first friction plate 56 is supported by the head 23c of the rivets 23 connecting the strap plates 59, it is unnecessary to add a new component to support the first friction plate 56, thereby preventing the number of components from increasing.

Since the rivets 23 are disposed in the recesses 98 between the adjacent protrusions 97 formed at the clutch plate 53 and the retaining plate 54 (more specifically, in the spaces defined between the adjacent fixing portions 77 of the clutch plate 53 in the circumferential direction), it is possible to reduce the axial dimension of the lock-up device 5, and to ensure easily the space S3 into which the strap plates 59 are elastically deformed in the axial direction.

Furthermore, since the inlet flow path area and the outlet flow path area in the vicinity of the frictional surfaces of the first friction plate 56 is generally the same as each other, the operating oils flow smoothly in the vicinity of the first friction plate 56 and the second friction plate 57. Consequently, the responsiveness at the lock-up engagement and disengagement operation can be improved, and the drag torque at the lock-up disengagement operation can be reduced.

### (5) Other Embodiments

The concrete structures of the present invention are not limited to the above-described embodiments, and various changes and modifications are possible within the scope of the present invention.

For example, although a torque converter is used as an example of hydraulic torque transmitting devices having a lock-up device in the above-described embodiment, a fluid coupling may be employed.

Furthermore, although the rivets 23 are described as an example of the member provided in the piston in the above-described embodiment, the member may be screws such as bolts and nuts or a member integral with the piston 51. In other words, the member provided in the piston means a member that is formed integral with the piston 51 or fixed to the piston 51 so as to move in the axial and rotational directions integrally with the piston 51, and includes an example in which the piston 51 is a separate member as well as an example in which the member is a part of the piston 51. In addition, the rivets 23 being made of the head 23c, the shank 23a and the fixing portion 23b may be a plurality of members connected to realize each parts as well as an integral member.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

### General Interpretation of Terms

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers, and/or steps. The foregoing also applies to words having similar meanings such as the terms, “including,” “having” and their derivatives. Also, the terms “part,” “section,” “portion,” “member,” or “element” when used in the singular can have the dual meaning of a single part or a plurality of parts. As used herein to describe the present invention, the following directional terms “forward, rearward, above, downward, vertical, horizontal, below, and transverse” as well as any other similar directional terms refer to those directions of a hydraulic torque transmitting device equipped with the present invention. Accordingly, these terms, as utilized to describe the present invention should be interpreted relative to a hydraulic torque transmitting device equipped with the present invention as used in the normal riding position. Finally, terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A lock-up device for a hydrodynamic torque transmission device, the device being located between a front cover and a turbine to connect mechanically the front cover with the turbine, comprising:
a piston being axially movably and rotatably supported by the turbine;
a damper mechanism elastically connecting the piston with the turbine in a rotational direction;
a first friction plate being located between the front cover and the piston, and being non-rotatably supported by the piston; and
a second friction plate being axially movably and non-rotatably located between the piston and the first friction plate, and being supported by the front cover.

2. The lock-up device for a hydrodynamic torque transmission device according to claim 1, wherein the first friction plate is axially movably supported by the piston.

3. The lock-up device for a hydrodynamic torque transmission device according to claim 2, wherein the first friction plate is formed with a connecting hole into which a member provided in the piston is fitted in the axial direction.

4. The lock-up device for a hydrodynamic torque transmission device according to claim 3, wherein the first friction plate has a tubular portion that extends in the axial direction and has an inner circumference corresponding to the connecting hole.

5. The lock-up device for a hydrodynamic torque transmission device according to claim 4, wherein the damper mechanism includes a driven member that is non-rotatably connected to the turbine, a drive member arranged to be rotatable relative to the driven member, an elastic member that elastically connects the drive member with the driven member in the rotational direction, and a connecting member that non-rotatably connects the piston with the drive member elastically in the axial direction, and the connecting member is connected to the piston by the member provided in the piston.

6. The lock-up device for a hydrodynamic torque transmission device according to claim 5, wherein the member provided in the piston has a shank that penetrates the piston and the connecting member in the axial direction, a fixing portion that is formed at one end of the shank and has the outer diameter larger than that of the shank, and a head that is formed at the other end of the shank to pinch the piston and the connecting member between the fixing portion and the head, the head having an outer diameter larger than that of the shank, and
the first friction plate is supported by the head such that first friction plate can move in the axial direction relative to the piston.

7. The lock-up device for a hydrodynamic torque transmission device according to claim 6, wherein the head is fitted into the connecting hole.

8. The lock-up device for a hydrodynamic torque transmission device according to claim 2, wherein the damper mechanism includes a driven member that is non-rotatably connected to the turbine, a drive member arranged to be rotatable relative to the driven member, an elastic member that elastically connects the drive member with the driven member in the rotational direction, and a connecting member that axially movably and non-rotatably connects the piston with the drive member,
the drive member further has an annular drive member main body, and a plurality of protrusions that extends radially outward from the drive member main body,
one end of the connecting member is fixed to the protrusion, and
the other end of the connecting member is fixed to the piston by the member provided in the piston, the member provided in the piston is located between the adjacent protrusions.

9. The lock-up device for a hydrodynamic torque transmission device according to claim 1, wherein the second friction plate has an engagement portion that is axially movably and non-rotatably engaged with the front cover, and
a flow path area of the engagement portion is substantially same as a flow passage area between the front cover and a radially inner portion of the second friction plate in the axial direction.

10. A hydraulic torque transmitting device, comprising:
a front cover being configured to receive torque from an engine;
an impeller forming a fluid chamber with the front cover:
a turbine being located opposed to the impeller; and
a lock-up device being located between the front cover and the turbine to connect mechanically the front cover with the turbine, the lock-up device having
a piston being axially movably and rotatably supported by the turbine,
a damper mechanism elastically connecting the piston with the turbine in a rotational direction,
a first friction plate being located between the front cover and the piston, and being non-rotatably supported by the piston, and
a second friction plate being axially movably and non-rotatably located between the piston and the first friction plate, and being supported by the front cover.

11. The hydraulic torque transmitting device according to claim 10, wherein the first friction plate is axially movably supported by the piston.

12. The hydraulic torque transmitting device according to claim 11, wherein the first friction plate is formed with a connecting hole into which a member provided in the piston is fitted in the axial direction.

13. The hydraulic torque transmitting device according to claim 12, wherein the first friction plate has a tubular portion that extends in the axial direction and has an inner circumference corresponding to the connecting hole.

14. The hydraulic torque transmitting device according to claim 13, wherein the damper mechanism includes a driven member that is non-rotatably connected to the turbine, a drive member arranged to be rotatable relative to the driven member, an elastic member that elastically connects the drive member with the driven member in the rotational direction, and a connecting member that non-rotatably connects the piston with the drive member elastically in the axial direction, and
the connecting member is connected to the piston by the member provided in the piston.

15. The hydraulic torque transmitting device according to claim 14, wherein the member provided in the piston has a shank that penetrates the piston and the connecting member in the axial direction, a fixing portion that is formed at one end of the shank and has the outer diameter larger than that of the shank, and a head that is formed at the other end of the shank to pinch the piston and the connecting member between the fixing portion and the head, the head having an outer diameter larger than that of the shank, and
the first friction plate is supported by the head such that first friction plate can move in the axial direction relative to the piston.

16. The hydraulic torque transmitting device according to claim 15, wherein the head is fitted into the connecting hole.

17. The lock-up device for a hydrodynamic torque transmission device according to claim 11, wherein the damper mechanism includes a driven member that is non-rotatably connected to the turbine, a drive member arranged to be rotatable relative to the driven member, an elastic member that elastically connects the drive member with the driven member in the rotational direction, and a connecting member that axially movably and non-rotatably connects the piston with the drive member,
the drive member further has an annular drive member main body, and a plurality of protrusions that extends radially outward from the drive member main body,
one end of the connecting member is fixed to the protrusion, and
the other end of the connecting member is fixed to the piston by the member provided in the piston, the member provided in the piston is located between the adjacent protrusions.

18. The lock-up device for a hydrodynamic torque transmission device according to claim 10, wherein the second friction plate has an engagement portion that is axially movably and non-rotatably engaged with the front cover, and
a flow path area of the engagement portion is substantially same as a flow passage area between the front cover and a radially inner portion of the second friction plate in the axial direction.
